(19) United States
(12) Patent Application Publication
(10) Pub. No.: US 2005/0269267 A1
(43) Pub. Date: Dec. 8, 2005

(54) Separations platform based upon electroosmosis-driven planar chromatography

(75) Inventors: Wayne F. Patton, Newton, MA (US); Mack J. Schermer, Belmont, MA (US)

Correspondence Address: WILMER CUTLER PICKERING HALE AND DORR LLP, 60 STATE STREET, BOSTON, MA, 02109, US

(73) Assignee: PerkinElmer LAS, Inc., Boston, MA (US)

(21) Appl. No.: 11/084,501

(22) Filed: Mar. 18, 2005

Related U.S. Application Data
(60) Provisional application No. 60/521,250, filed on Mar. 19, 2004.

(51) Int. Cl. B01D 15/08

(52) U.S. Cl. 210/656; 210/748; 204/450; 436/161

(57) ABSTRACT

The present invention describes a system and method for separation of proteins, peptides and glycans by one-dimensional or two-dimensional electroosmosis-driven planar chromatography. Separation is performed using amphiphilic polymeric membranes, amphiphilic thin-layer chromatography plates or other planar amphiphilic surfaces as the stationary phase with a combination of organic and/or aqueous buffers as the mobile phase. Systematic selection of stationary phase supports, mobile phase buffers and operating conditions allow for the adaptation of the invention to a broad range of applications in proteomics, mass spectrometry, drug discovery and the pharmaceutical sciences.

### CROSS-REFERENCE TO RELATED APPLICATIONS

The application claims benefit of U.S. provisional patent application No. 60/521,250, filed Mar. 19, 2004.

### FIELD OF THE INVENTION

The present invention generally relates to the separation of proteins, peptides and glycans using electroosmosis-driven planar chromatography. The present invention also relates to systems and methods for separating biomolecules using planar electrochromatography.

### BACKGROUND OF INVENTION

The human proteome is known to contain approximately 30,000 different genes. But, due to post-translational modifications and differential mRNA splicing, the total number of distinct proteins is most likely to be close to one million. The level of complexity, coupled with the relative abundances of different proteins, presents unique challenges in terms of separations technologies. Analytical methods for the simultaneous quantitative analysis of the abundances, locations, modifications, temporal changes and interactions of thousands of proteins are important to proteomics. Two-dimensional or even multi-dimensional protein separations, based upon different physicochemical properties of the constituent proteins, are favored over single dimension separations in proteomics due to the increased resolution afforded by the additional dimensions of fractionation. Two-dimensional separation systems can be categorized by the type of interface between the dimensions. In “heart-cutting” methods a region of interest is selected from the first dimension and the selected region is subjected to second dimension separation. Systems that subject the entire first dimension to a second dimension separation, or alternatively sample the effluent from the first dimension at regular intervals and fixed volumes for subsequent fractionation in the second dimension, are referred to as “comprehensive” methods.

The principal protein separation technology used today is high-resolution two-dimensional gel electrophoresis (2DGE). High resolution 2DGE involves the separation of proteins in the first dimension according to their charge by isoelectric focusing and in the second dimension according to their relative mobility by sodium dodecyl sulfate polyacrylamide gel electrophoresis. The technique is capable of simultaneously resolving thousands of polypeptides as a constellation pattern of spots, and is used for the global analysis of metabolic processes such as protein synthesis, glycolysis, gluconeogenesis, nucleotide biosynthesis, amino acid biosynthesis, lipid metabolism and stress response. It is also used for the analysis of signal transduction pathways, to detect global changes in signaling events, as well as to differentiate between changes in protein expression and degradation from changes arising through post-translational modification.

Polyacrylamide gels are mechanically fragile, susceptible to stretching and breaking during handling. Analysis using 2DGE produces a random pattern of smudged, watery ink spots on a wobbly, sagging, gelatinous-like slab. Other limitations include difficulty in automating the separation process, low throughput of samples, and difficulty in detecting low abundance, extremely basic, very hydrophobic, very high molecular weight or very low molecular weight proteins. While detection of proteins directly in gels with labeled antibodies or lectins has been accomplished, the approach is not generally applicable to every antigen and is relatively insensitive. Consequently, proteins are usually electrophoretically transferred to polymeric membranes before specific targets are identified. The polyacrylamide gel also poses difficulties in the identification of proteins by microchemical characterization techniques, such as mass spectrometry, since the gels must be macerated and rinsed, the proteins must be incubated with proteolytic enzymes, and peptides must be selectively retrieved and concentrated using a reverse-phase column prior to identification.

Integral membrane proteins play an important role in signal transduction and are thus primary drug targets pursued by the pharmaceutical industry. The proteins typically contain one or more hydrophobic, transmembrane domains that intermingle with the hydrophobic portion of lipid bilayer membranes. The 2DGE technique is poorly suited for the fractionation of hydrophobic proteins, particularly proteins containing two or more alpha-helical transmembrane domains, because the technique is based upon aqueous buffers and hydrophilic polymers.

Two-dimensional liquid chromatography-tandem mass spectrometry (2D LC/MS/MS) has been used as an alternative analytical approach for protein separation. In 2D LC/MS/MS, a proteolytic digest of a complex protein sample is loaded onto a microcapillary column that is packed with two independent chromatography phases, a strong cation exchanger and a reverse-phase material. Peptides are iteratively eluted directly into a tandem mass spectrometer and the spectra generated are correlated to theoretical mass spectra obtained from protein or DNA databases. This peptide-based approach to proteomics generates large number of peptides from a specimen that exceeds the analytical capacity of the LC-MS system. Consequently, strategies have been developed that retrieve a small percentage (3-5%) of the peptides from a complex digest, such as tryptic peptides containing only cysteine residues or only histidine residues. The remaining 95-98% of the peptides are discarded, thus prohibiting a comprehensive analysis of the sample. Additionally, such procedures are unable to distinguish among the various protein isoforms exhibited in a proteome that arise from differential mRNA splicing and post-translational modification due to a combination of poor sequence coverage and the sequence scrambling arising from the fragmentation process itself.

Another technique applied to the analysis of peptides and proteins is capillary electrochromatography (CEC), but its use has been limited to 1-D capillary separations of model analytes. CEC is a hybrid separation technique that couples capillary zone electrophoresis (CZE) with high-performance liquid chromatography (HPLC). In CEC, both chromatographic and electrophoretic processes determine the magnitude of the overall migration rates of the analytes. Unlike HPLC, where the dominant force is hydraulic flow, the driving force in CEC is electroosmotic flow. When a high voltage is applied, positive ions accumulate in the electric double layer of the particles in the column packing and move towards the cathode, dragging the liquid phase with them. The separation mechanism in CEC is based upon both kinetic processes (electrokinetic migration) and thermodynamic processes (partitioning). This combination reduces band broadening and thus allows for higher separation efficiencies.

Electroosmotic flow depends upon the surface charge density, the field strength, and the thickness of the electric double layer and the viscosity of the separation medium, which in turn depends upon the temperature. Electroosmotic flow is highly dependent upon pH, buffer concentration (ionic strength), the organic modifier and the type of stationary phase employed. CEC separations can be performed isocratically, thus dispensing with the requirement for gradient elution, which in turn simplifies instrumentation requirements.

Other techniques for protein separations include the use of planar electrophoresis and membrane electrophoresis, such as electrically-driven cellulose filter paper-based separation of proteins, where hydrophilic cellulose-based filter paper is utilized as the stationary phase and dilute aqueous phosphate buffer as the electrode buffer. Using this technique, plasma proteins could be separated in the first dimension by electrophoresis and in the second dimension by paper chromatography. The cellulose polymer is too hydrophilic to provide for significant binding of proteins to the solid-phase surface. Thus, the proteins interact minimally with filter paper in aqueous medium, and once the applied current is removed the separation pattern will degrade rapidly due to diffusion. In the case of cellulose acetate membranes, electroosmosis is often minimized through derivatization of the acetate moieties with agents such as boron trifluoride and separations are subsequently achieved by conventional isoelectric focusing. The cellulose acetate membranes are considered extremely fragile for diagnostic applications in clinical settings and the generated profiles of very hydrophilic proteins, such as urinary and serum proteins, are poor compared to those generated with polyacrylamide gels.

Another electrically-driven polymeric membrane-based separation process includes electromolecular propulsion (EMP) which involves the use of complex nonaqueous mobile phase buffers composed of four or more different organic solvents that are free of electrically conductive trace contaminants.

### SUMMARY OF INVENTION

One aspect of the present invention provides a high resolution protein, peptide and glycan separation system that employs a solid phase support and simple combinations of organic and aqueous mobile phases to facilitate the fractionation of biological species by a combination of electrophoretic and/or chromatographic mechanisms. The separation system includes mechanical stability of the separating medium, accessibility of the analytes to post-separation characterization techniques (immunodetection, mass spectrometry), ability to fractionate hydrophobic analytes and large molecular complexes, and minimizes sample consumption, number of manual manipulations and timelines for performing the actual fractionation.

In one aspect of the invention, a method of separating biomolecules is provided. The method includes the steps of providing a sample comprising one or more biomolecules, loading the sample on a planar stationary phase, wherein the stationary phase is amphiphilic; contacting the stationary phase with a first liquid mobile phase, providing a first and a second electrode in electronic contact with opposing edges of the stationary phase; and creating an electrical field between the first electrode and the second electrode so as to cause the first liquid mobile phase to be advanced across the length of the stationary phase, whereby one or more biomolecules are separated.

In one or more embodiments, the biomolecule is selected from the group consisting of proteins, peptides, amino acids, oligosaccharides, glycans and small drug molecules. In one or more embodiments, the pH, ionic strength and water/organic content of the mobile phase are selected to promote electroosmosis-driven separation.

In one or more embodiments, the liquid mobile phase is an aqueous mixure containing a water miscible organic liquid. The liquid mobile phase may be selected from a group consisting of methanol-aqueous buffer; acetonitrile-aqueous buffer; ethanol-aqueous buffer; isopropyl alcohol-aqueous buffer; butanol-aqueous buffer; isobutyl alcohol-aqueous buffer; carbonate-aqueous buffer; furfuryl alcohol-aqueous buffer; and mixtures thereof.

In one or more embodiments, the amphiphilic planar stationary phase includes a hydrophobic polymer derivatized with ionic groups. The ionic group is selected from one or more of sulfonic acid, sulfopropyl, carboxymethyl, phosphate, diethylaminoethyl, diethylmethylaminoethyl, allylamine and quartenary ammonium residues. The hydrophobic polymer is selected from the group consisting of polyvinylidine difluoride, polytetrafluoroethylene, poly(methyl methacrylate), polystyrene, polyethylene, polyester, polyurethane, polypropylene, nylon and polychlorotrifluoroethylene. The deriviatized hydrophobic polymer may be particulate.

In one or more embodiments, the planar stationary phase includes a silica, alumina or titania based thin layer chromatography resin derivatized with alkyl groups, aromatic groups, or cyanoalkyl groups. The planar stationary phase may include silica, alumina or titania-particles derivatized with alkyl, aromatic or cyanoalkyl groups

In one or more embodiments, the planar stationary phase includes pores of about 30 nanometers to about 100 nanometers in diameter. The planar stationary phase may be made up of particles having a diameter of about 3 microns to about 50 microns.

In one or more embodiments, the separation method further includes the step of applying a second electrical potential between the first electrode and the second electrode so as to cause a second liquid mobile phase to be advanced across the length of the stationary phase in a second direction, whereby one or more biomolecules are separated. The pH, ionic strength and water/organic content of the mobile phase may be selected to promote electroosmosis-driven separation in both the first and second directions. Alternatively, the pH, ionic strength and water/organic content of the mobile phase may be selected to promote electroosmosis-driven separation in one direction and chromatographic separation in another direction.

In one or more embodiments, the first and second mobile phases have different pHs. In one embodiment, the pH of the first mobile phase is acidic and the pH of the second mobile phase is basic; and in other embodiments, the pH of the first mobile phase is basic and the pH of the second mobile phase is acidic.

In one or more embodiments, the first and second mobile phase have different organic content. In one embodiment, the first liquid mobile phase has a higher organic solvent concentration than the second liquid mobile phase; and in other embodiments, the first liquid mobile phase has a lower organic solvent concentration than the second liquid mobile phase.

In one or more embodiments, the first and second liquid mobile phases have different ionic strengths.

In one or more embodiments, the separation method further includes the step of detecting the separated biomolecules. Detection is selected from the group consisting of fluorescence, mass spectrometry, chemiluminescence, radioactivity, evanescent wave, label-free mass detection, optical absorption and reflection. The biomolecules are labeled with a detection agent prior to or after separation. The detection agent is selected from the group consisting of colored dyes, fluorescent dyes, chemiluminescent dyes, biotinylated labels, radioactive labels, affinity labels, mass tags, and enzymes.

In one or more embodiments, the separations method includes mass tagging the biomolecules for differential analysis of protein expression changes and post-translational modification changes.

In another aspect of the invention, an electrochromatography system for the separation of biomolecules includes a chamber having at least bottom and side walls defining a planar electrochromatography area, a first region within the chamber for containing a liquid mobile phase, a second region within the chamber for containing a liquid mobile phase, a planar amphiphilic stationary phase positioned between the first and second regions within the chamber and in contact with the liquid mobile phase, first and second electrodes capable of electronic contact with opposing sides of the planar amphiphilic stationary phase, and a power source capable of generating an applied electric potential between the first and second electrodes for performing planar electrochromatography.

In one or more embodiments, the first and second electrodes and the planar stationary phase are in contact with a planar wick. The wick is selected from a group consisting of cellulose-based filter paper, Rayon fiber, buffer-impregnated agarose gel, and moistened paper towel. In one embodiment, the end of the wick is in contact with the liquid phase in the first region and second end of the wick is in contact with the liquid phase in the second region.

In one embodiment, a first wick is in contact with the liquid phase in the first region and the second wick is in contact with the liquid phase in the second region. In another embodiment, a first end of the stationary phase is in contact with a first wick and the first electrode, and an opposing end of the stationary phase is in contact with a second wick and the second electrode.

In one or more embodiments, the stationary phase is held between two holders by mechanical fastener. The holders are frames with openings in the center for contacting the stationary phase with the liquid mobile phase. The holder includes alignment means for positioning the stationary phase held between two holders by mechanical means within the chamber. The alignment means is selected from a group consisting of holes, slots, pins, datum surfaces and datum features.

In one or more embodiments, the system further includes a dispenser for dispensing a sample on the planar stationary phase. The dispenser is manual or automated. The manual dispenser is selected from a group consisting of pipette, piezo-electric dispensing tip, solid pin, and quill pin. The automated dispenser is an automated pipetting dispenser or reagent spotting or printing instrument.

In one or more embodiments, the system further includes a controller for controlling the power supply unit, wherein the controlling means is selected from a group consisting of a computer, a programmable controller, a microprocessor, and a timer.

In another aspect of the invention, a kit for conducting electrochromatography is provided. The kit includes a planar amphiphilic stationary phase for loading a sample comprising one or more biomolecules, at least one buffer solution, and an instruction booklet outlining instructions on how to use the kit for separating a sample containing two or more biomolecules using planar electrochromatography.

In one or more embodiments, the kit further includes a wick, wherein the wick is selected from a group consisting of cellulose-based filter paper, Rayon fiber, buffer-impregnated agarose gel, and moistened paper towel.

In one or more embodiments, the kit further includes an impermeable barrier to cover the stationary phase, wherein the impermeable barrier is glass plate or silicone oil.

In yet another aspect of the invention, a cassette is provided, which includes a frame having a base, side walls and a cover and having an inlet port and an outlet port for introducing and removing a fluid, and a stationary phase supported in the frame, the stationary phase including an amphiphilic stationary phase. The cassette may further include a pair of electrodes integral with the cover and located at first opposing side walls of the frame. The cassette may further include a second electrode pair integral with the cover and located at second opposing side walls of the frame.

### BRIEF DESCRIPTION OF DRAWINGS

FIG. 1 is a schematic representation of a planar stationary phase in contact with a first mobile phase, having a sample spotted near the center and an electric field applied in a first direction in accordance with the present invention.

FIG. 2 illustrates a sample separated in one dimension in accordance with the present invention.

FIG. 3 illustrates a sample separated in two dimensions in accordance with one or more embodiments of the present invention.

FIG. 4 is a schematic representation of an apparatus in accordance with one or more embodiments of the present invention.

FIG. 5 is a schematic representation of an apparatus in accordance with one embodiment of the present invention.

FIG. 6 is a schematic representation of an apparatus in accordance with a second embodiment of the present invention.

FIG. 7 is a schematic representation of an apparatus in accordance with a third embodiment of the present invention.

FIG. 8 illustrates means for supporting the stationary phase with respect to alignment features in accordance with one or more embodiments of the present invention.

FIG. 9 illustrates spotting of two samples on a stationary phase prior to simultaneous separation under nearly identical conditions.

FIG. 10 is an illustration of two simultaneous separations resulting from applying the two-dimensional separation method to two samples.

FIG. 11 is an illustration of cassette including a planar stationary phase and electrode pairs.

FIG. 12 illustrates a reagent loading and washing station that may be used in conjunction with a cassette to semi-automate the separations process.

FIG. 13 illustrates a planar electrochromatographic separations station that may be used in conjunction with a cassette to semi-automate the separations process.

### DETAILED DESCRIPTION

System and methods for separation of biomolecules, e.g., proteins, peptides, amino acids, oligosaccharides, glycans and even small drug molecules, using electroosmosis-driven planar chromatography are described. In electroosmosis-driven planar chromatography an amphiphilic polymeric membrane, amphiphilic thin-layer chromatography plate or similar planar substrate provides the stationary phase for the separation platform. The planar substrate surface is characterized by a combination of charge carrying groups (ion exchangers), non-covalent groups (counterions), and nonionic groups that facilitate chemical interactions with the analyte, e.g., proteins or peptides. In a method for the separation of biomolecules using a planar electrochromatographic system, electroosmotic flow is generated by application of a voltage across the planar support in the presence of a miscible organic solvent-aqueous buffer mobile phase. Charged ions accumulate at the electrical double layer of the solid-phase support and move towards the electrode of opposite charge, dragging the liquid mobile phase along with them. Charged biomolecules are separated due to both the partitioning between the liquid phase and the solid phase support and the effects of differential electromigration.

According to one or more embodiment of the present, upon completion of separation in one direction, e.g., the first dimension separation, the solid phase is rinsed, incubated in a second organic solvent-aqueous buffer mobile phase and then fractionated in a direction that differs from the original direction of separation (e.g., the second dimension separation). Typically, the second direction is perpendicular to the first direction. In one or more embodiments, both dimensions are separated by the partitioning effects between the liquid phase and solid support and effects of electromigration. By adjusting the pH, ionic strength and organic solvent concentration, electrophoretic separation in one dimension is obtained and separation in second dimension is obtained chromatographically.

Although the systems and methods described herein may be used for any charged molecule, the invention is described with reference to the separation of proteins, peptides and glycans. Such description is for convenience only and is not intended to limit the invention. Application of the systems and methods described to other molecules will be apparent from the description which follows.

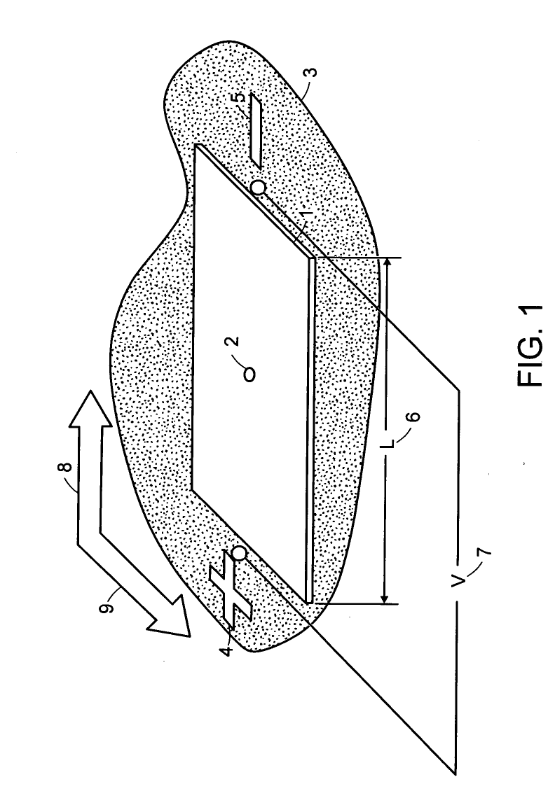

FIG. 1 shows a sample spotted near the center of a planar stationary phase in contact with a first mobile phase and an electric field applied in a first direction in accordance with one embodiment of the present invention. Referring to FIG. 1, a planar stationary phase 1, particularly in the form of a membrane, is wetted by a first mobile phase 3 shown as a puddle surrounding the membrane. A small volume of a sample 2 is dispensed or spotted for example, by hand, on top of the stationary phase, near the center of the stationary phase. In other embodiments, spotting is performed by dispensing the sample with a pipette, a piezo-electric dispensing tip, a solid or quill pin. Spotting may be located anywhere on the membrane and location maybe determined, in part, by the anticipated direction and extent of electromigration of the species. In another embodiment, precise location in spotting can be achieved using a Multiprobe liquid handling robot (PerkinElmer) capable of automated spotting of single locations or array spotting. An electric field characterized by positive 4 and negative 5 potentials is applied across a first direction 8 of stationary phase 1. The applied potential 7 and dimension of the length 6, across which the potential is applied, characterize the magnitude of the electric field.

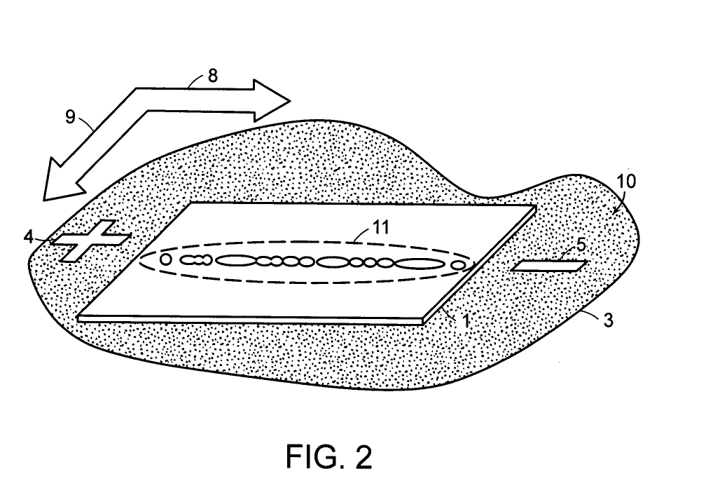

FIG. 2 shows sample 2 on the planar stationary phase 1 after a period of separation in the first dimension 8. Sample 2 is separated into multiple spots 11, some distinct and some overlapping. This first dimension separation occurs along a line in the direction of the applied potential 7.

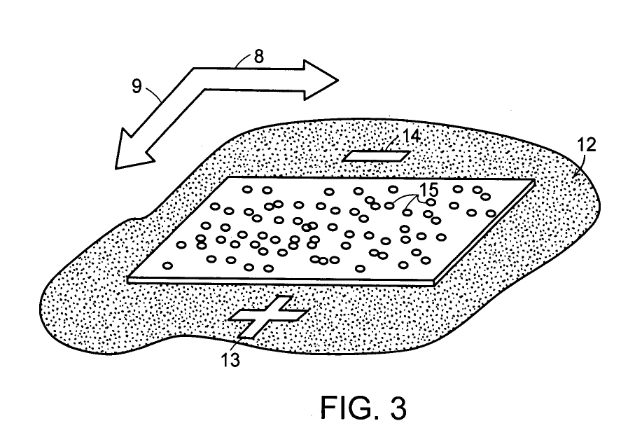

FIG. 3 shows the separated sample on planar stationary phase 1 after both a separation in a first dimension 8 and a separation in a second dimension 9. Prior to the second dimension separation, first mobile phase 3 is removed and a second mobile phase 12 is applied to the stationary phase. A second electric field, characterized by positive 13 and negative 14 potentials, is applied across the stationary phase in the second dimension 9.

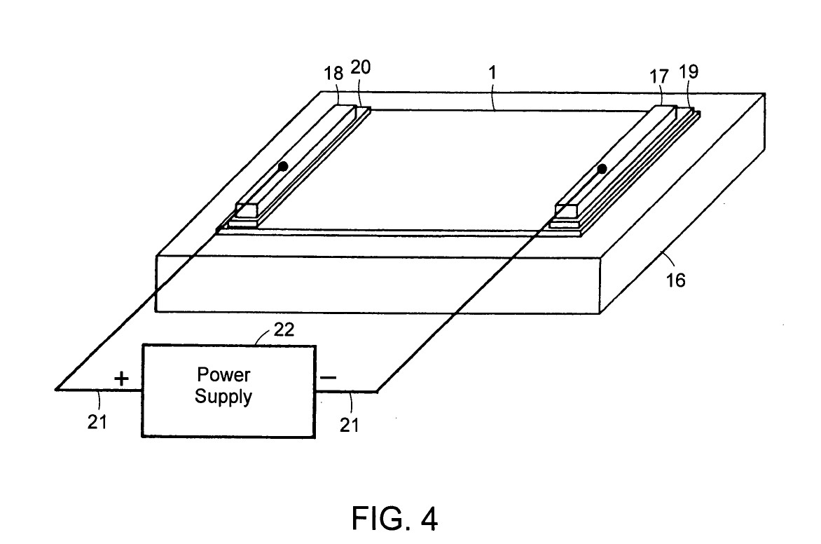

FIG. 4 is a schematic diagram of an apparatus for carrying out the invention. Referring to FIG. 4, planar stationary phase 1 is placed on a fixture or support 16 and a mobile phase (not shown) is applied to stationary phase 1. Support 16 may be solid, porous, or contain reservoirs or cavities to retain a supply of mobile phase to keep the stationary phase wet during separation. Exemplary support materials include PTFE (Teflon), Macor machineable ceramic, glass, or other compatible materials. Electrodes 17 and 18 are placed on top of stationary phase 1, with wire leads 21 connecting the electrodes to a power supply 22. In one embodiment, the electrodes are made of non-reactive metals. Exemplary non-reactive metals include platinum, palladium, or gold. The electrodes may be in the shape of rectangular bars, wires, rods, or any other shape with sufficient length to substantially span the width of the stationary phase. In one embodiment in accordance with the present invention, power supply 22 is a high-voltage DC supply. Power supply 22 may be controlled by a computer, a programmable controller, a microprocessor, a timer or the like in order to precisely control the separation conditions for more reproducible results.

In some embodiments, connection pads 19 and 20 are placed between the electrodes and the stationary phase to ensure a continuous electrical connection along the entire lengths of electrodes 17 and 18. In another embodiment of the present invention, connection pads 19 and 20 are made of filter paper.

In one or more embodiments, planar stationary phase 1 is rotated, e.g., by about 90 degrees, after a separation in first dimension 8 to facilitate another separation in second dimension 9. Prior to separation in the second dimension 9, first mobile phase 3 is removed and a second mobile phase 12 is applied to the stationary phase. Electrodes 17 and 18 are placed on top of stationary phase 1, with wire leads 21 connecting the electrodes to a power supply 22. A second electric field is applied across the stationary phase in the second dimension 9.

In another embodiment, electrodes 17 and 18 are placed on top of planar stationary phase 1 along second dimension 9 after a separation in first dimension 8. Prior to separation in the second dimension 9, first mobile phase 3 is removed and a second mobile phase 12 is applied to the stationary phase. A second electric field is applied across the stationary phase in the second dimension 9.

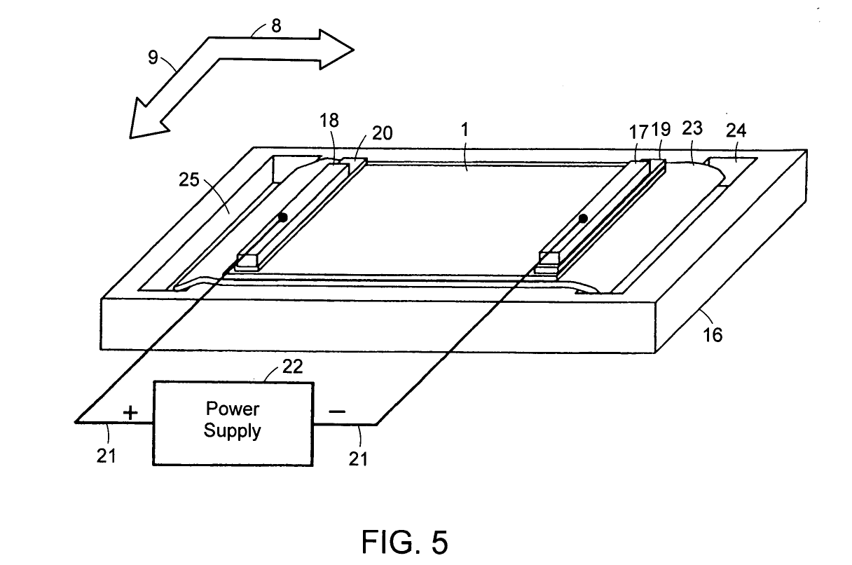

FIG. 5 shows an alternate embodiment of the present invention, where a wick 23 is placed beneath planar stationary phase 1. Wick 23 is at least as wide as stationary phase 1 in the separation direction 9 and longer than stationary phase 1 in the separation direction 8. Wick 23 protrudes beyond the ends of the stationary phase and is placed in reservoirs 24 and 25 containing additional liquid mobile phase. Capillary action draws mobile phase from the reservoirs and into wick 23, keeping the wick and the adjacent stationary phase 1 soaked in liquid mobile phase at all times during separation. Electrodes 17 and 18 are applied to the top of stationary phase 1. In one embodiment, wick 23 is made of filter paper.

In an alternate embodiment, planar stationary phase 1 and wick 23 are rotated, e.g., by about 90 degrees, after a separation in first dimension 8 to facilitate another separation in second dimension 9. Prior to separation in the second dimension 9, first mobile phase 3 is removed and a second mobile phase 12 is applied to the stationary phase. Electrodes 17 and 18 are placed on top of stationary phase 1, with wire leads 21 connecting the electrodes to a power supply 22. A second electric field is applied across the stationary phase in the second dimension 9.

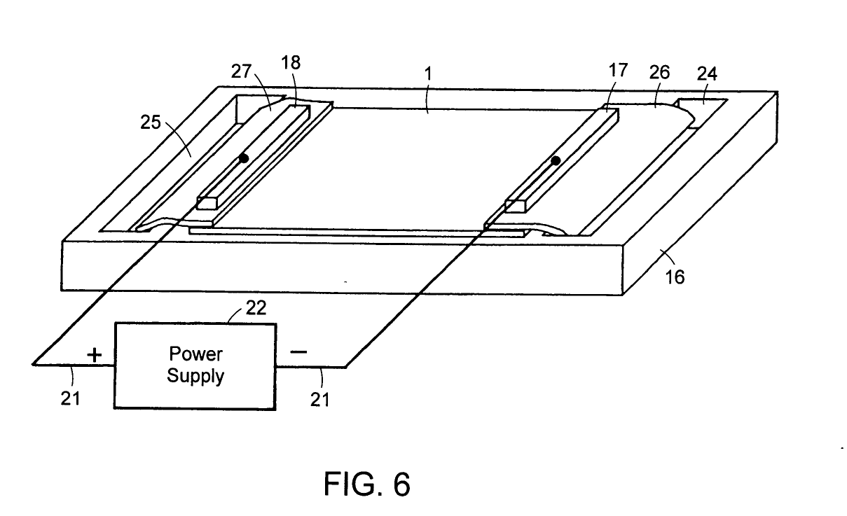

FIG. 6 shows an alternate embodiment of a separation apparatus of the present invention, where planar stationary phase 1 is placed directly on the support 16. Short wicks 26 and 27 are placed between electrodes 17 and 18 and stationary phase 1. Wicks 26 and 27 extend from under electrodes 17 and 18 to the mobile phase reservoirs 24 and 25. Wicks 26 and 27 do not extend beyond electrodes 17 and 18 toward the center of stationary phase 1. Capillary action of wicks 26 and 27 draws liquid mobile phase from reservoirs 24 and 25 to stationary phase 1 but do not provide a parallel electrical conduction path across the separation area of stationary phase 1.

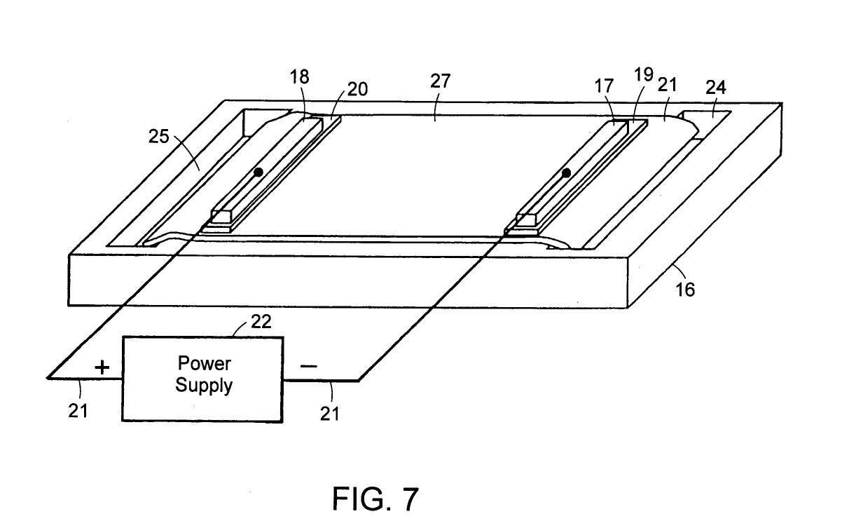

FIG. 7 shows another embodiment of a separation apparatus in accordance with the present invention. Referring to FIG. 7, a stationary phase 27 is placed on the support 16 without a wick. The length of stationary phase 27 is such that the ends of stationary phase 27 protrude into mobile phase reservoirs 24 and 25, beneath the surface of the liquid mobile phase. Capillary action of stationary phase 27 draws liquid mobile phase from reservoirs 24 and 25 to the rest of stationary phase 27. Electrodes 17 and 18 are applied to the top of stationary phase 27.

In another embodiment of the present invention, electrodes 17 and 18 are placed in reservoirs 24 and 25. Electrodes 17 and 18 are in complete contact with the mobile phase and the liquid mobile phase conducts current to the stationary phase.

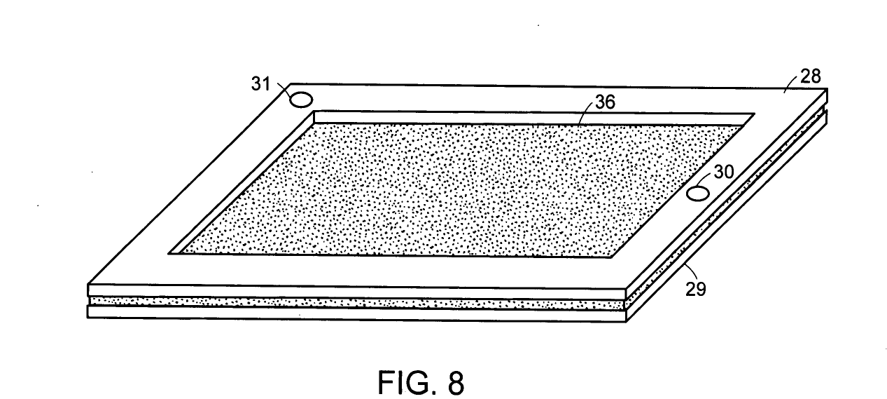

FIG. 8 shows another means for holding a stationary phase to a separation apparatus in accordance with one or more embodiments of the present invention. Referring to FIG. 8, stationary phase 36 is held between two rigid or semi-rigid holders 28 and 29. Holders 28 and 29 are in the form of frames with large openings in the center where the stationary phase is exposed for application of sample, mobile phase, wicks, contact pads, or electrodes. The large openings also facilitate optical access to the stationary phase, allowing imaging the stationary phase after separation is completed. The stationary phase is clamped between the two holders in the manner of a sandwich using rivets, eyelets, screws, snap tabs, heat staking or other mechanical means to fix the two holders together. Alignment features 30 and 31, such as holes, slots, pins or the like, could be used to align stationary phase 36 on a separation apparatus in accordance with one or more embodiments of the present invention. The alignment feature allows precise registration to other instruments, such as imaging instruments, spot excising instruments, mass spectrometers, etc. Alignment features 30 and 31 allow the precise coordinates of separated spots located using one instrument to be transferred to another instrument.

The planar stationary phase support includes a frame for supporting a planar stationary phase and a fastener for securing the planar stationary phase to the frame. The frame is open in a center portion for exposing a surface of the planar stationary phase, and the open center portion is substantially the size of the planar stationary phase to optimize contact of the planar stationary phase with buffers and other liquids. The frame may include a recess for receiving a planar stationary phase. The planar stationary phase may be either a polymer membrane or a silica, alumina or titania-based thin layer chromatography resin.

The planar stationary phase support may include two opposing frames, in which the frames are configured to secure a planar stationary between the opposing frames. The planar stationary phase support may be secured to the frame by a mechanical fastener. Exemplary mechanical fastener include rivets, eyelets, screws, snaps, tabs, clamps, and gaskets. The planar stationary phase may also be secured using a crimp or fold of a portion of the frame over an edge of the planar stationary phase. The planar stationary phase may be secured to the frame by a chemical fastener, such as a thermal weld, heat stake, bonding agent or adhesive.

The planar stationary phase includes alignment of the planar stationary phase relative to a predetermined location. Alignment is accomplished by registration of a feature or immobilizing the frame with respect to a predetermiend location. Such feature or immobilizing means is located at an edge of the frame or on a face of the frame. The frame may be aligned using an indentation or projection that is positionable to register with a complimentary indentation or projection. Exemplary projections or indentations include holes, slots, and pins. The alignment means may be a spring set that is positionable to repeatably locate the frame relative to a reference location.

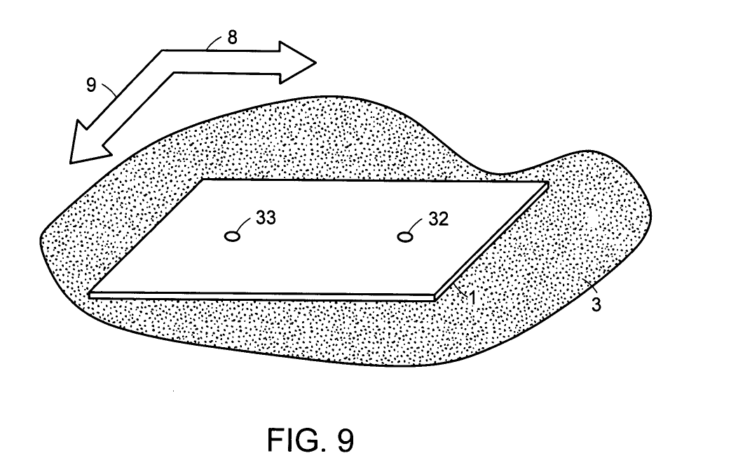

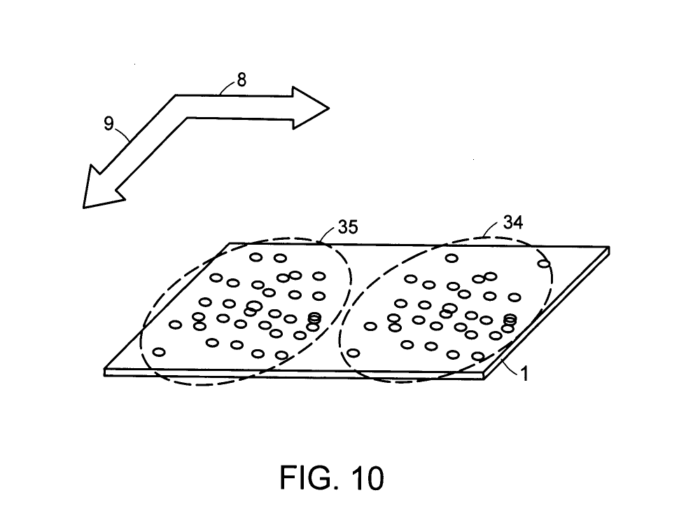

FIGS. 9 and 10 show another embodiment in accordance with the present invention where samples 32 and 33 are spotted on planar stationary phase 1 and are separated simultaneously into two-dimensional (2D) separation patterns 34 and 35. When similar mobile phase, electric fields, temperature, and other operating conditions are applied to a plurality of samples, multiple separation patterns, as shown in FIG. 10, is obtained. This technique allows the assessment of differential protein expression, for example, where the differences in the separation patterns correspond to differences in protein contents between the samples.

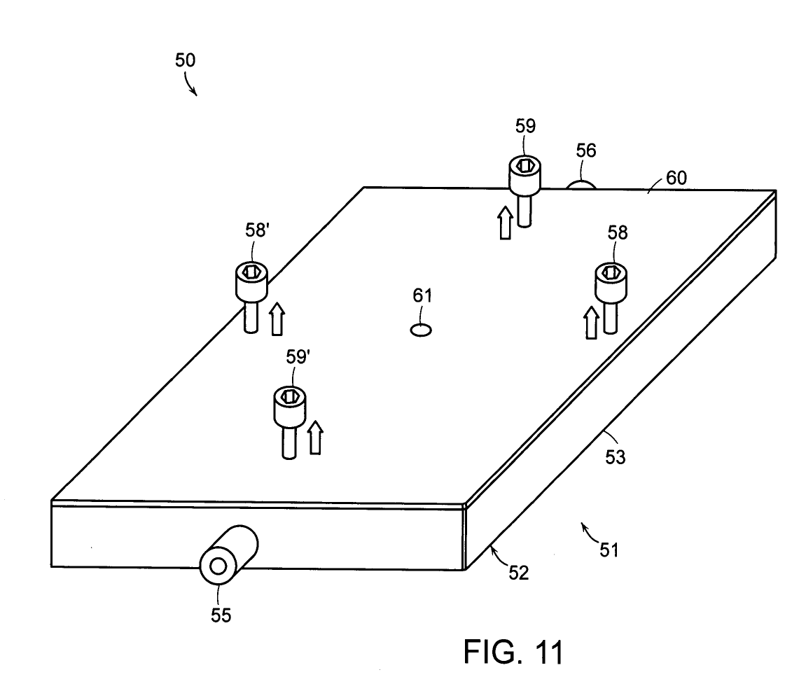

FIG. 11 shows a portable cassette 50 that can be used in a planar electrochromatographic separation apparatus. The cassette includes a frame 51 having a base 52 and side walls 53. The planar stationary phase (not shown) is supported within the frame. The frame is equipped with an inlet port 55 and an outlet port 56 for introducing and removing a fluid from the cassette interior, such as a buffer or washing liquids. The cassette 50 further includes a cover 60. The cover 60 may be transparent to permit imaging or detection in real time or without the need to remove the stationery phase from the cassette. The cover 60 may also include electrode pairs 58, 58′ and 59, 59′ as an integral component of the cover. The electrodes are built in to the cassette and are located near opposing side walls of the frame. The electrodes can be spring loaded or otherwise mounted so that they can be reversibly engaged with the stationary phase. This features permits the electric field to be established in two orthogonal directions. The cover also includes a sample loading port 61.

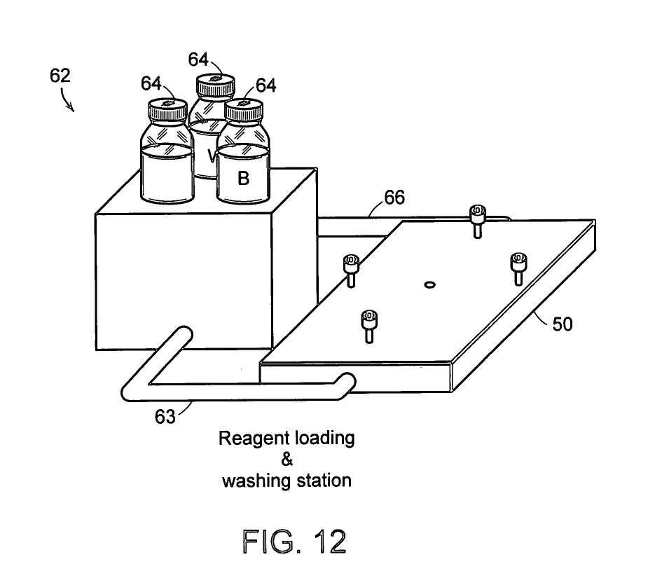

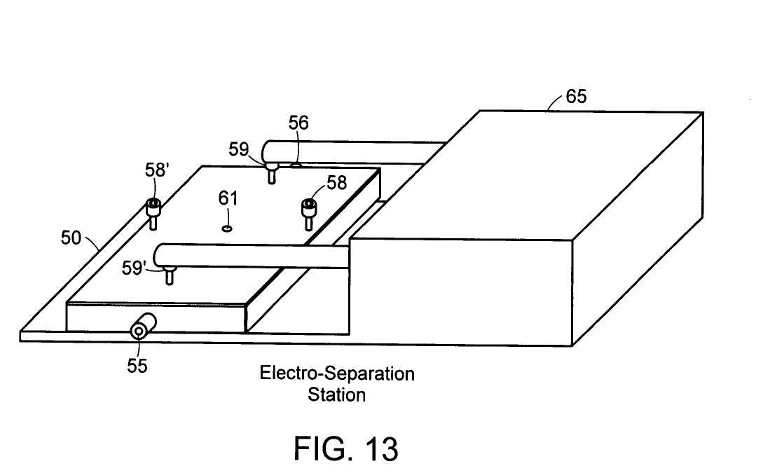

In other embodiments, cassette 50 is integrated into a semi-automated process, as illustrated in FIGS. 12 and 13. FIG. 12 shows a reagent loading and washing station including cassette 50 and pump station 62. Pump station 62 includes automated pumps (not shown) for delivery of fluid, e.g., buffer solution and washing fluids, through conduits 63 from reservoir 64 to the cassette.

Fluids exit the cassette through conduit 66 and are stored in a container (not shown). Thus, buffer loading, stationary phase rinsing and other fluid transfers are carried out without movement or transfer of the planar stationary phase.

FIG. 13 shows a electrochromatographic separation station 65 that is integrated with cassette 50 by connection to the first electrode pair 59, 59′. Reagent loading station 62 (not shown) is connected to the cassette through inlet and outlet parts 55, 59. In operation, a sample is manually loaded onto the planar stationary phase in the cassette through loading port 61 and the pump injects a first buffer or liquid mobile phase into the appropriate port of the cassette. A voltage then is applied and separation is performed in the first dimension. The pump station then washes the planar stationary phase to remove the first buffer and injects a second buffer or liquid mobile phase. The cassette is repositioned at electrochromatographic separation station 65 and is connected using the second electrode pair 58, 58′. The second separation in the second direction is then performed and the planar stationary phase is rinsed to remove the second buffer or mobile phase. The stationary phase is then manually stained or otherwise treated for detection.

In one or more embodiments, the separations system includes a cover. First and second electrodes are integral with the cover and located at first opposing side walls of the chamber. Third and fourth electrodes may be integral with the cover and are located at second opposing side walls of the chamber.

Fully automated systems that incorporate the features of automated proteomic systems are also contemplated.

As used herein, an “amphiphilic stationary phase” refers to a solid-support stationary phase exhibiting both non-polar and polar interactions with the analyte, e.g., proteins, glycans or peptides. An amphiphilic stationary phase includes regions, phases or domains that are nonionic and/or hydrophobic in nature as well as regions, phases or domains that are highly polar and preferably ionic. The ionic regions can be positively or negatively charged. Hydrophobic groups favor the interaction and retention of the protein during separation, while the ionic groups promote the formation of the charged double layer used in electrokinetic separation. In one embodiment, the amphiphilic stationary phase for protein fractionation has a combination of charge carrying groups (ion exchangers), non-covalent groups, and nonionic groups that facilitate chemical interactions with the analytes. In another embodiment, the amphiphilic stationary phase is predominantly hydrophobic, but partially ionic in character.

Examples of amphiphilic stationary phase that can be used for protein separation includes hydrophobic planar support derivatized with sulfonic acid, sulfopropyl, carboxymethyl, phosphate, diethylaminoethyl, diethylmethylaminoethy, allylamine or quartenary ammonium residues or the like. Hydrophobic planar supports derivatized with sulfonic acid, sulfopropyl, carboxymethyl, or phosphate residues enable cathodic electroosmotic flow, while hydrophobic planar supports derivatized with diethylaminoethyl, diethylmethylaminoethy, allylamine or quartenary ammonium residues enable anodic electroosmotic flow. Membranes, particulate thin-layer chromatography substrates, large pore mesoporous substrates, grafted gigaporous substrates, gel-filled gigaporous substrates, nonporous reversed phase packing material and polymeric monoliths are contemplated.

Membranes include polymeric sheets, optionally derivatized to provide the amphiphilic character of the planar stationary phase. Exemplary hydrophobic membranes for membrane-based electrochromatography of proteins and peptides include Perfluorosulfonic Nafion® 117 membrane (Dupont Corporation), partially sulfonated PVDF membrane, sulfonated polytetrafluoroethylene grafted with polystyrene, polychlorotrifluoroethylene grafted with polystyrene, or the like. Sulfonation of polyvinylidene difluoride (PVDF) can be achieved by incubation with sulfuric acid at a moderately high temperature. The degree of sulfonation can be systematically varied, where ion exchange capability of 0.25 meq/g is considered as “moderate” sulfonation. In these membranes separation depends upon the electrostatic interaction of proteins with sulfonated residues in combination with hydrophobic interactions with aromatic residues in the substrate. At pH in the range from about pH 2.0 to about pH 11.0, the protonated primary amine groups on the proteins will interact with sulfonated residues on the membrane. This interaction is diminished at pH greater than about pH 11.0. Sulfonate residues will be protonated at a pH less than about pH 2.0 and will lead to a decline in the electroosmosis driving force of the separation.

In some embodiments, PVDF membranes, used for the isolation by electroblotting of proteins separated by gel electrophoresis, can be derivatized with cationic functional groups in order to generate an amphiphilic membrane (e.g., Immobilon-CD protein sequencing membrane (Millipore Corporation)). For example, PVDF membrane can be etched with 0.5 M alcoholic KOH and subsequently reacted with polyallylamine under alkaline conditions. As another example, PVDF membranes can be derivatized with diethylaminoethyl or quartenary ammonium residues.

In some embodiments, the membrane is unsupported. In other embodiments, the membrane is supported or semi-supported. For example, the membrane can be held between two rigid or semi-rigid holders in the form of frames with large openings in the center. The membrane may also be rigidly supported on a solid support, for example, a glass plate. Membranes may be substantially non-porous. In such instances, the mobile phase moves over the surface of the membrane. In other embodiments, the membrane may be porous, in which case the mobile phase moves through the pores and/or channels of the membrane. Separation occurs by preferential interactions of the proteins with the hydrophobic surfaces or the interstial surfaces of the membrane.

As another example, a planar stationary phase useful for separation of proteins include silica thin-layer chromatography plates derivatized with alkyl groups (e.g. C₃-C₁₈ surface chemistry), aromatic phenyl residues, cyanopropyl residues or the like. In these instances, the silanol groups provide the ion exchange qualities of the amphiphilic support and can be deprotonated at a pH of 8, leading to electroosmosis and thereby providing the ion exchange qualities of the amphiphilic support. At pH below pH 3, there will be a reduction or elimination in electroosmosis. In some embodiments, both hydrophobic groups, e.g., alkyl, and charged groups, e.g., sulfonic acid, can be attached to the same silica particle. As a further example, a stationary phase support for the separation of peptides and proteins by planar electrochromatography includes a gamma-glycidoxypropyltrimethoxysilane sublayer attached to the silica support of a thin-layer chromatography plate. A sulfonated layer is then covalently affixed between the sublayer and an octadecyl top layer. For separation of proteins in the 10 and 100 kDa range using a silica-based stationary phase, it is expected that derivitization with C8 and C4 groups, respectively, may be used. Phenyl functionalities are slightly less hydrophobic than C4 functionalities and may be advantageous for the separation of certain polypeptides.

The planar stationary phase includes pores or connected pathways of a dimension that permits unimpeded migration of the proteins. For particulate stationary phases, such as silica thin-layer chromatography plates or particulate-based polymer membranes, the stationary phase consists of particles that form pores of about 30-100 nanometers in diameter, although for some smaller peptides with molecular weights of 2,000 daltons or less, 10 nanometers pores may be acceptable. Typical absorbants commercially available for thin-layer chromatography are made of particles that form pores sizes of only 1-6 nm, which precludes effective use for protein separations. The particles may have a diameter of about 3-50 microns, with the smaller diameter particles typically producing higher resolution protein separations. For higher protein loads, large particle absorbents are preferable. This is particularly advantageous for the preparative scale isolation of proteins. The size distribution of the particles should be relatively narrow and particles are preferably spherical, rather than irregularly shaped. While the base material of the particles can be silica, synthetic polymers, such as polystyrene-divinylbenzene (or any of the above mentioned hydrophobic polymers) are also expected to be appropriate.

The liquid mobile phase typically includes an organic phase and an aqueous phase. Exemplary mobile phases include methanol-aqueous buffer, acetonitrile-aqueous buffer, ethanol-aqueous buffer, isopropyl alcohol-aqueous buffer, butanol-aqueous buffer, isobutyl alcohol-aqueous buffer, propylene carbonate-aqueous buffer, furfuryl alcohol-aqueous buffer systems or the like. The basic principles of electrochromatography provide the foundation for systematic selection of stationary phase supports, mobile phase buffers and operating conditions, and allow for the adaptation of the technology to a broad range of applications in proteomics, drug discovery and the pharmaceutical sciences. As with CEC, mobile phases rich in organic modulators will exhibit relatively little chromatographic retention and in mobile phases low in organic modulator, chromatographic retention will dominate the separation process.

In one embodiment of the present invention, the concentrations of organic modulators in liquid mobile phases are in the range of about 0% to about 60%. In another embodiment, the ionic strength of liquid mobile phases can be from about 2 mM to about 150 mM. Exemplary liquid mobile phase formulations include 20 mM ammonium acetate, pH 4.4, 20% acetonitrile; 2.5 mM ammonium acetate, pH 9.4, 50% acetonitrile; 25 mM Tris-HCl, pH 8.0/acetonitrile (40/60 mix); 10-25 mM sodium acetate, pH 4.5, 55% acetonitrile; 60 mM sodium phosphate, pH 2.5/30% acetonitrile; 5 mM borate, pH 10.0, 50% acetonitrile; 5-20 mM sodium phosphate, pH 2.5, 35-65% acetonitrile; 30 mM potassium phosphate, pH 3.0, 60% acetonitrile and 10 mM sodium tetraborate, 30% acetonitrile, 0.1% trifluoroacetic acid; 20% methanol, 80% 10 mM MES, pH 6.5, 5 mM sodium dodecyl sulfate; 20% methanol, 80% 10 mM MES, pH 6.5, 5 mM sodium phosphate, pH 7.0/methanol (4:1, v/v); 4 mM Tris, 47 mM glycine, pH 8.1; 20 mM sodium phosphate, pH 6.0, 150 mM NaCl; 20 mM Tris-HCl, pH 7.0, 150 mM NaCl; 5 mM sodium borate, pH 10.0; or the like.

In some embodiments, different cathode and anode buffers could be used as a discontinuous buffer system for the separation of proteins. In certain of these embodiments, the amphiphilic stationary phase could be incubated in a buffer that is compositionally different from either electrode buffer. Additives, such as carrier ampholytes may be included in the buffer in which the stationary phase is incubated. In other embodiments, the composition of the mobile phase could be altered temporally to provide a composition gradient that facilitates separation of proteins.

In two-dimensional separation of proteins on an amphiphilic stationary phase using planar electrochromatography, protein sample is applied on the center of the membrane (dry or pre-wetted with mobile phase) and the planar stationary phase is then incubated in a mobile phase. Once the proteins are electrophoretically separated in one direction, the planar stationary phase is washed and incubated in a second mobile phase, and then electrophoretically separated in a direction perpendicular to the first direction. In one embodiment in accordance with the present invention, liquid mobile phases can be adjusted to different pH values, concentrations of organic solvent, and ionic strengths to facilitate 2D separations of proteins on the amphiphilic substrate. For example, one mobile phase will have acidic pH (ca. pH 4.5) and the other basic pH (ca pH 8.5). The pH of the buffers will affect the total charge of the individual protein species and thus influence their electrokinetic migration. Changes to the concentration of organic solvent in liquid mobile phase will impact the strength of interaction of the proteins with the hydrophobic component of the stationary phase. Finally, the ionic strength of the buffer will change the separation properties of the proteins in the two dimensions. By manipulating pH, ionic strength and organic solvent concentration, separation in one dimension will occur electrophoretically and separation in the other dimension will occur chromatographically.

Protein samples are prepared by first dissolving the proteins in the mobile phase or a weaker solvent of lower ionic strength. In some embodiments, “biological buffers”, such as Good's buffers, are used for sample preparation. These biological buffers produce lower currents than inorganic salts, thereby allowing the use of higher sample concentrations and higher field strengths. Exemplary Good's buffers include N-(2-Acetamido)-2-aminoethanesulfonic acid (ACES), N-(2-Acetamido)iminodiacetic acid (ADA), N,N-Bis(2-hydroxyethyl)-2-aminoethanesulfonic acid (BES), N,N-Bis(2-hydroxyethyl)glycine (BICINE), Bis(2-hydroxyethyl)iminotris(hydroxylmethyl)methane (BIS-TRIS), N-Cyclohexyl-3-aminopropanesulfonic acid (CAPS), N-Cyclohexyl-2-hydroxy-3-aminopropanesulfonic acid (CAPSO), N-Cyclohexyl-2-aminoethanesulfonic acid (CHES), 3-[N,N-Bis(hydroxyethyl)amino]-2-hydroxypropanesulfonic acid (DIPSO), 3-[4-(2-Hydroxyethyl)-1-piperazinyl]propanesulfonic acid (EPPS), 2-[4-(2-Hydroxyethyl)-1-piperazinyl]ethanesulfonic acid (HEPES), 2-Hydroxy-3-[4-(2-hydroxyethyl)-1-piperazinyl]-propanesulfonic acid, monohydrate (HEPPSO), 2-Morpholinoethanesulfonic acid, monohydrate (MES), 3-Morpholinopropanesulfonic acid (MOPS), 2-Hydroxy-3-morpholinopropanesulfonic acid (MOPSO), Piperazine-1,4-bis(2-ethanesulfonic acid) (PIPES), Piperazine-1,4-bis(2-ethanesulfonic acid), sesquisodium salt (PIPES, sesquisodium salt), Piperazine-1,4-bis(2-hydroxy-3-propanesulfonic acid), dehydrate (POPSO), N-Tris(hydroxymethyl)methyl-3-aminopropanesulfonic acid (TAPS), N-Tris(hydroxymethyl)methyl-2-hydroxy-3-aminopropanesulfonic acid (TAPSO), Tris-(hydroxymethyl)aminomethane (TRIS), N-Tris(hydroxymethyl)methyl-2-aminoethanesulfonic acid (TES), and N-[Tris(hydroxymethyl)methyl]glycine (TRICINE). If salts are used to facilitate extraction and isolation of the protein specimen, desalting of protein samples may be performed using reverse phase resins by organic solvent-based protein precipitation or by sample dialysis prior to sample fractionation by planar electrochromatography.

In some embodiments, protein samples are prepared by first dissolving the proteins in HPLC solvent systems thereby avoiding the use of detergents, chaotropes and strong organic acids for protein dissolution. HPLC solvent systems include buffered solutions containing organic solvents, such as methanol or acetonitrile, may be employed to prepare the biological specimens. For example, 60% methanol or acetonitrile, 40% water containing 0.1% formic acid or 60% methanol or acetonitrile, 40% 50 mM ammonium carbonate, pH 8.0 are suitable sample solubilization buffers. In one embodiment, final protein concentration in the solubilization buffer is from about 0.05 mg/ml to about 5 mg/ml. In another embodiment, final protein concentration in the solubilization buffer is from about 0.4 mg/ml to about 0.6 mg/ml. Extraction and solubilization of proteins can be facilitated by intermittent vortexing and sonication. Surfactants are well known to suppress peptide ionization in mass spectrometry and also to interfere with chromatographic separations, particularly with reversed-phase liquid chromatography. Buffered solutions containing organic solvents are more compatible with liquid chromatography and mass spectrometry and thus facilitate characterization of the proteins after planar electrochromatography. Another important advantage of the buffered organic solvent extraction procedure is that it facilitates solubilization, separation and identification of integral membrane proteins, including proteins containing transmembrane-spanning helices.

Planar electrochromatographic separation of peptides and proteins is performed by directly applying an electric field across the membrane or thin layer chromatography plate. In one embodiment, the planar surface may be interfaced with the electrical system through the use of wicks, also referred to as buffer strips. A wick is a solid or semisolid medium used to establish uniform electrical paths between the planar solid phase and the electrodes of a horizontal electrophoresis apparatus. For example, a wick may be composed of cellulose-based filter paper, Rayon fiber, buffer-impregnated agarose gel, moistened paper towel, or the like.

Application of an electric field in electrochromatographic systems could result in Joule heating which in turn could to lead to evaporation of liquid mobile phase from the membrane or plate surface. The evaporation of the mobile phase could result in decreased current, drying of the surface, and subsequent degradation in the quality of the separation. In one embodiment in accordance with the present invention, the planar stationary phase is covered with a glass plate, silicone oil or other impermeable barrier to reduce the evaporation of the mobile phase as a result of Joule heating. Further, flow of the mobile phase across the membrane or plate may be impeded in the forward direction, causing the electroosmotic flow to drive the liquid mobile phase to the surface of the membrane or plate. This can result in poor resolution separations and arcing of the electrophoretic device. Adjusting mobile phase pH or ionic strength will aid in optimizing conditions for the electrically driven separation. In one embodiment, operating current for protein or peptide separations is from about 10 μA to about 500 mA and the electric field strength applied to the separation is from about 50 volts/cm to about 900 volts/cm. In another embodiment, the electric field strength applied to the separation is from 200 volts/cm to about 600 volts/cm. In certain embodiments of the present invention, separations of proteins can be performed using constant voltage, constant current or constant power mode, the latter resulting in constant amount of Joule heating in the system.

In one or more embodiments, planar electrochromatography can be used with other electrophoresis modalities, such as immobilized metal affinity electrochromatography, immunoaffinity electrochromatography, zonal electrophoresis, electromolecular propulsion, electrokinetic chromatography, isoelectric focusing, nonequillibrium pH electrophoresis and micellar electrokinetic chromatography. In certain embodiments, a two component or dual phase planar substrate can be created. For example, immobilized metal ion affinity electrochromatography, followed by reverse-phase electrochromatography could be performed. One edge of the planar support, for example, a 1 cm strip along one side of the membrane, can be derivatized with metal-chelating groups (e.g., iminodiacetic acid, nitrilotriacetic acid) while the rest of the membrane will possess sulfonate ion exchange characteristics. The membrane will be charged with a metal ion, such as Ni(II), Cu(II), Ca(II), Fe(III) or Ga(III), and the chelating groups will selectively retain these metal ions. Protein sample can be applied as a discrete spot on the membrane and subjected to electrochromatographic separation along the length of the modified strip using a buffer appropriate for binding. In one embodiment, Fe(III)- or Ga(III)-charged membrane strips, 20 mM sodium acetate, pH 4.0 can be used. Upon completion of first fractionation, the membrane is rinsed in a second buffer and subjected to electrochromatography in a direction perpendicular to the direction of original separation. A comparison of the profile generated with the described membrane to a profile generated from a membrane lacking the metal chelating strip will reveal metal-binding proteins as spots whose migration is altered between the two profiles. Other combined modalities of separation are envisioned, including cation exchange electrochromatography and reverse-phase electrochromatography.

Proteins, peptides and glycans may be detected after planar electrochromatography using a variety of detection modalities well known to those skilled in the art. Exemplary strategies employed for general protein detection include organic dye staining, silver staining, radio-labeling, fluorescent staining (pre-labeling, post-staining), chemiluminescent staining, mass spectrometry-based approaches, negative-staining approaches, contact detection methods, direct measurement of the inherent fluorescence of proteins, evanescent wave, label-free mass detection, optical absorption and reflection, or the like. In negative-staining approaches, the proteins remain unlabeled, but unoccupied sites on the planar surface are stained. In contact detection methods, another membrane or filter paper that has been imbibed with a substrate is placed in contact with the planar surface and protein species resident on the planar stationary phase interact with the substrate molecules to generate a product. In direct measurement of the inherent fluorescence of proteins, solid-phase supports of low inherent fluorescence are used. Exemplary detection methods suitable for revealing protein post-translational modifications include methods for the detection of glycoproteins, phosphoproteins, proteolytic modifications, S-nitrosylation, arginine methylation and ADP-ribosylation. Exemplary methods for the detection of a range of reporter enzymes and epitope tags include methods for visualizing β-glucuronidase, β-galactosidase, oligohistidine tags, and green fluorescent protein. For optimal performance of these detection technologies, it will be necessary to use solid-phase supports of low inherent fluorescence.

Protein samples that have undergone planar electrochromatography appear as discrete spots on the strip that are accessible to staining or immunolabeling as well as to analysis by various detection methods. Exemplary detection methods include mass spectrometry, Edman-based protein sequencing, or other micro-characterization techniques. In one embodiment, proteins bound to the surface of the membrane can be labeled by reagents, such as, antibodies, peptide antibody mimetics, oligonucleotide aptamers, quantum dots, Luminex beads or the like.

In some embodiments, chemiluminescence-based detection of proteins on planar surfaces can be used prior to or after fractionation by planar electrochromatography. In one embodiment, proteins can be biotinylated and then detected using horseradish peroxidase-conjugated streptavidin and the Western Lightning Chemiluminescence kit (PerkinElmer). In another embodiment, proteins may be fluorescently stained or labeled and the fluorescent dye subsequently chemically excited by nonenzymatic means, such as the bis(2,4,6-trichlorophenyl)oxalate (TCPO)-H₂O₂ reaction.

Separations of protein, using the method in accordance with one or more embodiments of the present invention, can be achieved in a short duration. Proteins are spotted on a planar substrate, subjected to first dimension separation, rinsed and subjected to second dimension separation thereby providing access to the proteins and peptides on the surface of the stationary phase for detection. In one embodiment, SYPRO Ruby protein blot stain (Molecular Probes) is capable of detecting proteins on a surface within about 15 minutes. Additionally, the planar support itself serves as a mechanically strong support, allowing archiving of the separation profiles without the need for vacuum gel drying.

In certain embodiments of the present invention, planar electrochromatography can be used to fractionate very large proteins, very small proteins, highly acidic proteins, highly basic proteins and hydrophobic proteins. In some embodiments, large multi-subunit complexes can be fractionated on the surface of a membrane. In one embodiment, mobile phases containing high concentrations of organic solvents are used to separate hydrophobic integral membrane proteins. In another embodiment, planar electrochromatography can be used to separate “electrophoretically silent” mutations, wherein proteins and peptides differ only by an uncharged amino acid residue. In a further embodiment, the planar electrochromatography system can be used to fractionate intact proteins. This is advantageous with respect to the analysis of protein isoforms arising from post-translational modification or differential splicing.

Proteomics studies are often based upon the comparison of different protein profiles. The central objective of differential display proteomics is to increase the information content of proteomics studies through multiplexed analysis. Currently, two principal gel-based approaches to differential display proteomics are being actively pursued, difference gel electrophoresis (DIGE) and Multiplexed Proteomics (MP). In one embodiment in accordance with the present invention, planar electrochromatography can be used with difference gel electrophoresis (DIGE) to increase the information content of proteomics studies through multiplexed analysis. Succinimidyl esters of the cyanine dyes (e.g., Cy2, Cy3 and Cy5) can be employed to fluorescently label as many as three different complex protein populations prior to mixing and running them simultaneously on the same 2D gel using DIGE. Images of the 2D gels are acquired using three different excitation/emission filter combinations, and the ratio of the differently colored fluorescent signals is used to find protein differences among the samples. DIGE allows two to three samples to be separated under identical electrophoretic conditions, simplifying the process of registering and matching the gel images. DIGE can be used to examine differences between two samples (e.g., drug-treated-vs-control cells or diseased-vs-healthy tissue). The principle benefit of the planar electrochromatography technology detailed in this disclosure with respect to DIGE is that protein separations can be achieved more quickly and samples are more readily evaluated by mass spectrometry after profile differences are determined. One requirement of DIGE is that from about 1% to about 2% of the lysine residues in the proteins be fluorescently modified, so that the solubility of the labeled proteins is maintained during electrophoresis. Very high degrees of labeling can be achieved when separations are performed by the planar electrochromatography technique, due to the fact that organic solvents are employed in the mobile phase and sample buffers. High degrees of labeling should in turn dramatically improve detection sensitivity using the DIGE technology.

In another embodiment, planar electrochromatography can be used with Multiplexed Proteomics to increase the information content of proteomics studies through multiplexed analysis. The Multiplexed Proteomics (MP) platform is designed to allow the parallel determination of protein expression levels as well as certain functional attributes of the proteins, such as levels of glycosylation, levels of phosphorylation, drug-binding capabilities or drug-metabolizing capabilities. The MP technology platform utilizes the same fluorophore to measure proteins across all gels in a 2DGE database, and employs additional fluorophores with different excitation and/or emission maxima to accentuate specific functional attributes of the separated species. With the MP platform, a set of 2D gels is fluorescently stained and imaged to reveal some functional attribute of the proteins, such as drug-binding capability, or a particular post-translational modification. Then, protein expression levels are revealed in the same gels using a fluorescent total protein stain. Differential display comparisons are made by computer, using image analysis software, such as Z3 program (Compugen, Tel Aviv, Israel). All gels are imaged using the same excitation/emission filter sets and resulting images are then automatically matched, with the option of adding some manual anchor points to facilitate the process. Any two images can then be re-displayed as a single pseudo-colored map. In addition, quantitative information can be obtained in tabular form, with differential expression data calculated. With a gel imaging platform similar profiles from different gels, such as total protein patterns, are matched by computer; while dissimilar ones from the same gel, such as total protein patterns and glycoprotein patterns, are superimposed and matched by computer. In MP the gels must be serially stained and imaged, as succeeding stains mask their predecessors in polyacrylamide gels. In one embodiment, planar electrochromatography can be used to assist MP in simultaneous imaging of multiple signals on profiles generated. Fluorescent dyes do not have the same strong tendency to mask one another on polymeric membranes.

In alternate embodiments, planar electrochromatrography can be used with MALDI-TOF MS for direct analysis of proteins. In this embodiment, proteins are fractionated on solid phase supports followed by direct probing with MALDI-TOF laser. In one embodiment, the planar electrochromatrography system in accordance with the present invention can be used with an orthogonal MALDI-TOF mass spectrometer (e.g., PrOTOF 2000 PerkinElmer, Boston, Mass., USA/MDS Sciex, Concord, ON, Canada). The prOTOF 2000 MALDI O-TOF mass spectrometer is a MS MALDI with orthogonal time of flight technology. The prOTOF's novel design provides improved instrument stability, resolution, and mass accuracy across a wide mass range compared with conventional linear or axial-based systems. The more accurate and complete protein identification achieved with the prOTOF 2000 reduces the need for peptide sequencing using more complicated tandem mass spectrometry techniques such as Q-TOF and TOF-TOF. The instrument is particularly well suited for planar electrochromatography because the MALDI source is decoupled from the TOF analyzer. As a result, any discrepancies arising from the solid phase surface topography or differential ionization of the sample from the surface are eliminated before the sample is actually delivered to the detector. The presentation of the proteins bound to a solid phase surface facilitates removal of contaminating buffer species and exposure to protein cleavage reagents (e.g., trypsin) prior to analysis by mass spectrometry. The use of HPLC-based buffers in the fractionation process minimizes the potential for downstream interference by detergents and chaotropes during mass spectrometry-based analysis.

Laser desorption of proteins by direct MALDI-TOF MS-based surface scanning of carrier ampholyte isoelectric focusing gels, immobilized pH gradient isoelectric focusing gels, native polyacrylamide gels, and SDS-polyacrylamide gels can be achieved, with sub-picomolar detection sensitivities. The procedure is currently quite slow, however, requiring a day to run the gel, two days to dry it down and two days to acquire spectra. In one embodiment of the present invention, planar electrochromatography can be used with MALDI-TOF MS for direct analysis of proteins by providing proteins conveniently affixed to solid phase supports and thus suitably presented for direct probing by the MALDI-TOF laser. “Virtual” 2D profiles can be generated by 1D planar electrochromatographic separations followed by desorbing proteins directly from the planar substrate using MALDI-TOF mass spectrometry, in effect substituting mass spectrometry for SDS polyacrylamide gel electrophoresis. Analytical data obtained can be presented as a computer-generated image with 2D gel type appearance. In another embodiment, planar electrochromatography can be used as a starting point for high throughput peptide mass fingerprinting and glycosylation analysis using chemical printing techniques such as piezoelectric pulsing where multiple chemical reactions are conducted on different regions of a spot by defined microdispensing of trypsin in-gel digestion procedures, and allowing peptide mass profiles and characterization of glycosylation, for example, to be achieved from the same spot. Defined microdispensing of trypsin and MALDI-TOF matrix solutions bypasses multiple liquid handling steps usually encountered with in-gel digestion procedures, and thus streamlines protein characterization methods.

In one or more embodiments, planar electrochromatography can be used with mass tagging techniques for differential display proteomics where relative abundances of different proteins in biological specimens are correlated with physiological changes. For example, Isotope-coded affinity tag (ICAT) peptide labeling is one such technique useful for distinguishing between two populations of proteins using isotope ratios. ICAT reagent employs a reactive functionality specific for the thiol group of cysteine residues in proteins and peptides. Two different isotope tags are generated by using linkers that contain either eight hydrogen atoms (do, light reagent) or eight deuterium atoms (d₈, heavy reagent). A reduced protein mixture from one protein specimen is derivatized with the isotopically light version of the ICAT reagent, while the other reduced protein specimen is derivatized with the isotopically heavy version of the ICAT reagent. Next, the two samples are combined, and proteolytically digested with trypsin or Lys-C to generate peptide fragments. The combined sample can be fractionated by planar electrochromatography. The ratio of the isotopic molecular weight peaks that differ by 8 daltons, as revealed by mass spectrometry, provides a measure of the relative amounts of each protein from the original samples. Other mass tagging approaches include growth of cells in either ¹⁴N— or ¹⁵N-enriched medium, use of regular water (H₂¹⁶O) and heavy water (H₂¹⁸O) as the solvent during Glu-C proteolysis of samples, use of acetate (d₀) and trideuteroacetate (d₃) to acetylate primary amino groups in peptides, methyl esterification of aspartate and glutamate residues using regular methanol (d₀) or trideuteromethanol (d₃), ¹²C and ¹³C labeled tri-alanine peptides iodoacetylated on their N-termini, and use of 1,2-ethanedithiol (d₀) and tetraalkyl deuterated 1,2-ethanedithiol (d₄) to measure differences between O-phosphorylation sites in samples using beta-elimination chemistry.

Recently, it has been demonstrated that the advantages of 2DGE and ICAT labeling technology can be combined into a single differential display platform. Proteins from two different samples are labeled with heavy and light ICAT reagents, combined and then separated by 2DGE. The gel-separated proteins are detected with a sensitive protein stain, excised, treated with protease and identified by peptide mass profiling. Additionally, selected peptides can be evaluated further using collision-induced dissociation (CID) and sequence database searching. One important application of ICAT differential display in 2D gels is for the assessment of the relative abundances of protein isoforms that arise from post-translational modification. In one embodiment of the present invention, 2D planar electrochromatography can be combined with ICAT labeling into a single platform for differential display proteomics using the ICAT reagents. Separations are much faster and the proteins are more amenable to downstream mass spectrometry-based analysis.

Mass tagging approaches based upon the same basic principles as the ICAT strategy include growth of cells in either ¹⁴N— or ¹⁵N-enriched medium, and the use of regular water (H₂¹⁶O) and heavy water (H₂¹⁸O) as the solvent during Glu-C proteolysis of samples, leading to the incorporation of two ¹⁸O or two ¹⁶O atoms in the C-terminal moiety of each proteolytic fragment. This results in a 4 dalton difference in mass between paired peptides. Acetate (d₀) and trideuteroacetate (d₃) can be employed to acetylate primary amino groups in peptides. Similarly, methyl esterification of aspartate and glutamate residues using regular methanol (d₀) or trideuteromethanol (d₃) can be used as an isotope tagging strategy. ¹²C and ¹³C labeled tri-alanine peptides iodoacetylated on their N-termini for mass tagging experiments. Finally, 1,2-ethanedithiol (d₀) and tetraalkyl deuterated 1,2-ethanedithiol (d₄) can be employed to measure differences between O-phosphorylation sites in samples using beta-elimination chemistry. The pendant sulfhydryl group is then reacted with biotin iodoacetamidyl-3,6-dioxaoctanediamine. In one embodiment of the present invention, 2D planar electrochromatography can be used with mass tagging technologies as a separation platform for differential analysis of protein expression changes and post-translational modification changes.

In one or more embodiments, planar electrochromatography can be used with inductively-coupled plasma mass spectrometry (ICP-MS) for the trace elemental analysis of metalloproteins, such as selenoproteins, zinc metalloenzymes, cadmium-binding proteins, cisplatin-binding drug targets, and myoglobins subsequent to fractionation by planar electrochromatography. Laser ablation ICP-MS permits trace element analysis by combining the spatial resolution of an ultraviolet laser beam with the mass resolution and element sensitivity of a modern ICP-MS. UV laser light, produced at a wavelength of 193-266 nm is focused on a sample surface, causing sample ablation. Ablation craters of 15-20 microns are routinely produced by the instrumentation. No special sample preparation is required for the procedure. Ablated material is transported in an argon carrier gas directly to the high temperature inductively-coupled plasma and the resulting ions are then drawn into a mass spectrometer for detection and counting. A mass filter selects particles on the basis of their charge/mass ratio so that only specific isotopes are allowed through the filter and can enter the electron multiplier detector mounted at the end of the mass spectrometer (quadrupole, magnetic sector or time-of-flight instrumentation). Detected signals of individual isotopes can be converted to isotopic ratios or, when standards are measured along with the unknowns, to the actual element concentrations.

Laser ablation ICP-MS can be used for directly measuring phosphorous as m/z 31 signal liberated from phosphoproteins on electroblot membranes. Using Laser ablation ICP-MS, 16 pmole of the pentaphosphorylated beta-casein can be detected on polymeric membranes. In another embodiment, planar electrochromatography can be used as a platform for the direct analysis of protein phosphorylation, without the use of radiolabels or surrogate dyes, such as Pro-Q Diamond phosphoprotein stain (Molecular Probes).

The detection of low concentrations of phosphorous presents certain analytical challenges for ICP-MS due to its poor ionization in the argon ICP and the presence of interfering polyatomic species directly at mass 31 (¹⁵N¹⁶O and ¹⁴N¹⁶O¹H) and indirectly at mass 32 (¹⁶O₂ and ³²S). Phosphorous has a high first ionization potential of 10.487 electron volts (Wilbur and McCurdy, 2001). This translates to a poor conversion of phosphorous (P) atoms to P+ ions in the inductively coupled plasma. In a well-optimized ICP-MS, this translates to a 6% conversion of P atoms to P+ ions, a relatively low response factor for ICP-MS. It is known to one skilled in the art that phosphate groups in proteins and peptides readily bind certain trivalent metal ions, such as aluminum (III), gallium (III) and iron (III). Using ICP-MS, as little as 1 part per billion (ppb) of these metal ions can be detected. The ionized conversion of aluminum, which has a first ionization potential of 5.986 electron volts, is 99% under identical run conditions as described for phosphorous. Thus, detecting aluminum instead of phosphorous improves detection 16-fold. In addition, the specific detection of the trivalent metal ions shifts the detection window away from the cited biological background signal. The atomic masses of aluminum, gallium and iron are 26.98, 69.7 and 55.85, respectively. Among these three trivalent metal ions, the ferric ion poses problems due to polyatomic interferences arising from ArN, ArO and AROH at the interface region of the ICP-MS. Gallium is probably the most suitable metal ion for the proposed application. Both ⁶⁹Ga, and ⁷¹Ga signal could be quantified by the method, minimizing the probability of overlapping signal from other molecular species.

The detection of proteins using ICP-MS-based detection procedure includes the following steps. First, proteins are separated by 2D planar electrochromatography as described in accordance with one embodiment of the present invention. The planar substrates are then incubated with 1 mM gallium chloride, 50 mM sodium acetate, pH 4.5, 50 mM magnesium chloride. Next, the planar substrates are washed repeatedly in 50 mM sodium acetate, pH 4.5, 50 mM magnesium chloride to remove excess metal ions. The individual spots on the planar surface are subjected to laser ablation ICP-MS methods where gallium signal is quantified rather than the phosphorous signal. Alternatively, the phosphorous signal can be read without incubating in the gallium solution. Sampling can be performed by single or multi-spot analysis, straight line scans or rastering. To aid in spot selection, the proteins on the planar substrate can be stained with a total protein stain, prior to the incubation with the gallium ions.

In one or more embodiments, planar electrochromatography can be used with protein microarrays for protein expression profiling and studying protein function. Planar electrochromatography can be used to provide a relatively simple method for generating protein microarrays. Small planar surfaces may be spotted with a defined mixture of proteins that are subsequently fractionated by 2D planar electrochromatography. Though the constituent proteins are not explicitly assigned a pre-determined coordinate in the resulting orthogonal matrix of spots thus generated, the identities of the spots can simply be determined by mass spectrometry, by immunodetection or by systematic omission of each protein from the mixture in subsequent separations. Once the location of each protein in the profile is known, the array may be used as conventional protein arrays, such as for profiling autoantibody responses in autoimmune disease and screening for other protein-protein, receptor-ligand, enzyme-substrate, enzyme-inhibitor or even protein-DNA interactions. The advantages of the arraying approach are that a dedicated pin-based or piezoelectric spotting device is not required and the membrane arrays are amenable to filter-based protein microarray techniques as described recently. For example, a filtration approach that allows multi-stacking of protein chips can be used for simultaneously probing with a particular reagent.

In one or more embodiments, planar electrochromatography can be used for examination of biomarkers associated with specific proteins present in plasma, urine, lymph, sputum and other biological fluids. Serum albumin in particular is a high abundance blood protein with broad binding capability that serves as a depot and transport protein for numerous exogenous and endogenous circulating compounds. Once plasma is fractionated into its constituent serum protein components using methods described in this invention, peptides associated with discrete proteins, such as albumin, haptoglobin, α₂-macroglobulin or immunoglobulin, may be selectively eluted and identified by mass spectrometry. The peptides can be acid eluted with 0.2% trifluoroacetic acid and can subsequently be concentrated using reversed phase resin prior to analysis. Using this technique, noncovalently bound peptides can be isolated from a variety of proteins, such as hsp 70, hsp 90 and grp 96. The advantage of one embodiment in accordance with the present invention is that it obviates the need for separating the peptides from the protein by a molecular weight cut-off membrane. Instead, the target protein remains affixed to the electrochromatography substrate and the peptides are eluted away from it.

In one or more embodiments, planar electrochromatography can be used for the fractionation of complex oligosaccharides, glycoproteins, glycolipids, proteoglycans, and oligosaccharides pre-derivatized with fluorophores (such as 8-aminonaphthalene-1,3,6-trisulfonic acid (ANTS) and 2-aminoacridone (AMAC)). Protein glycosylation is used for biochemical alterations associated with malignant transformation and tumorogenesis. Glycosylation changes in human carcinomas contribute to the malignant phenotype observed downstream of certain oncogenic events. Technologies that permit the rapid profiling of glycoconjugate isoforms with respect to oligosaccharide branching, sialyation and sulfation are invaluable tools in assessing the malignant nature of clinical cancer specimens.

The many features and advantages of the invention are apparent from the detailed specification, and thus, it is intended to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible.

1. A method of separating biomolecules comprising the steps of:
providing a sample comprising one or more biomolecules;
loading the sample on a planar stationary phase, wherein the stationary phase is amphiphilic;
contacting the stationary phase with a first liquid mobile phase;
providing a first and a second electrodes in electronic contact with opposing edges of the stationary phase; and
generating an electrical field between the first electrode and the second electrode so as to cause the first liquid mobile phase to be advanced across the length of the stationary phase, whereby one or more biomolecules are separated.

2. The method of claim 1, wherein the biomolecule is selected from the group consisting of proteins, peptides, amino acids, oligosaccharides, glycans and small drug molecules.

3. The method of claim 1, wherein the first and second liquid mobile phase has an ionic strength of about 2 mM to about 150 mM.

4. The method of claim 1, wherein the first liquid mobile phase is selected from a group consisting of methanol-aqueous buffer, acetonitrile-aqueous buffer, ethanol-aqueous buffer; isopropyl alcohol-aqueous buffer, butanol-aqueous buffer, isobutyl alcohol-aqueous buffer; carbonate-aqueous buffer, furfuryl alcohol-aqueous buffer, and mixtures thereof.

5. The method of claim 1, wherein the amphiphilic stationary phase comprises a hydrophobic polymer derivatized with ionic groups.

6. The method of claim 5 wherein the ionic group is selected from one or more of sulfonic acid, sulfopropyl, carboxymethyl, phosphate, diethylaminoethyl, diethylmethylaminoethyl, allylamine and quartenary ammonium residues.

7. The method of claim 5 wherein said hydrophobic polymer is selected from the group consisting of polyvinylidine difluoride, polytetrafluoroethylene, poly(methyl methacrylate), polystyrene, polyethylene, polyester, polyurethane, polypropylene, nylon and polychlorotrifluoroethylene.

8. The method of claim 1 wherein said planar stationary phase comprises a silica-, alumina- or titania-based thin layer chromatography resin derivatized with alkyl groups, aromatic groups, or cyanoalkyl groups.

9. The method of claim 1 wherein the planar stationary phase comprises silica-, alumina- or titania-particles derivatized with alkyl, aromatic or cyanoalkyl groups.

10. The method of claim 1 wherein the planar stationary phase comprises particulate hydrophobic polymer derivatized with ionic groups.

11. The method of claim 1, wherein the planar stationary phase comprises pores of about 30 namometers to about 100 nanometers in diameter.

12. The method of claim 1, wherein the planar stationary phase comprises particles having a diameter of about 3 microns to about 50 microns.

13. The method of claim 1 wherein the pH, ionic strength and water/organic content of said first mobile phase are selected to promote electroosmosis-riven separation.

14. The method of claim 1, further comprising the step of:
generating a second electrical potential between the first electrode and the second electrode so as to cause a second liquid mobile phase to be advanced across the length of the stationary phase in a second direction, whereby one or more biomolecules are separated.

15. The method of claim 14, wherein the separation by advancing first liquid mobile phase across the length of the stationary phase occurs electrokinetically, and wherein separation by advancing second liquid mobile phase across the length of the stationary phase occurs chromatographically.

16. The method of claim 14, wherein the first and second liquid mobile phases are selected from a group consisting of methanol-aqueous buffer; acetonitrile-aqueous buffer; ethanol-aqueous buffer; isopropyl alcohol-aqueous buffer; butanol-aqueous buffer; isobutyl alcohol-aqueous buffer; carbonate-aqueous buffer; furfuryl alcohol-aqueous buffer; and mixtures thereof.

17. The method of claim 14, wherein the first and second mobile phases have different pHs.

18. The method of claim 14 wherein the pH of the first mobile phase is acidic and the pH of the second mobile phase is basic.

19. The method of claim 14 wherein the pH of the first mobile phase is basic and the pH of the second mobile phase is acidic.

20. The method of claim 14, wherein the first and second mobile phase have different organic content.

21. The method of claim 14 wherein the first liquid mobile phase has a higher organic solvent concentration than the second liquid mobile phase.

22. The method of claim 14 wherein the first liquid mobile phase has a lower organic solvent concentration than the second liquid mobile phase.

23. The method of claim 14 wherein the first and second liquid mobile phases have different ionic strengths.

24. The method of claim 1 wherein said sample is dissolved in a buffer selected from the group consisting of N-(2-Acetamido)-2-aminoethanesulfonic acid (ACES), N-(2-Acetamido)iminodiacetic acid (ADA), N,N-Bis(2-hydroxyethyl)-2-aminoethanesulfonic acid (BES), N,N-Bis(2-hydroxyethyl)glycine (BICINE), Bis(2-hydroxyethyl)iminotris(hydroxylmethyl)methane (BIS-TRIS), N-Cyclohexyl-3-aminopropanesulfonic acid (CAPS), N-Cyclohexyl-2-hydroxy-3-aminopropanesulfonic acid (CAPSO), N-Cyclohexyl-2-aminoethanesulfonic acid (CHES), 3-[N,N-Bis(hydroxyethyl)amino]-2-hydroxypropanesulfonic acid (DIPSO), 3-[4-(2-Hydroxyethyl)-1-piperazinyl]propanesulfonic acid (EPPS), 2-[4-(2-Hydroxyethyl)-1-piperazinyl]ethanesulfonic acid (HEPES), 2-Hydroxy-3-[4-(2-hydroxyethyl)-1-piperazinyl]-propanesulfonic acid, monohydrate (HEPPSO), 2-Morpholinoethanesulfonic acid, monohydrate (MES), 3-Morpholinopropanesulfonic acid (MOPS), 2-Hydroxy-3-morpholinopropanesulfonic acid (MOPSO), Piperazine-1,4-bis(2-ethanesulfonic acid) (PIPES), Piperazine-1,4-bis(2-ethanesulfonic acid), sesquisodium salt (PIPES, sesquisodium salt), Piperazine-1,4-bis(2-hydroxy-3-propanesulfonic acid), dehydrate (POPSO), N-Tris(hydroxymethyl)methyl-3-aminopropanesulfonic acid (TAPS), N-Tris(hydroxymethyl)methyl-2-hydroxy-3-aminopropanesulfonic acid (TAPSO), Tris-(hydroxymethyl)aminomethane (TRIS), N-Tris(hydroxymethyl)methyl-2-aminoethanesulfonic acid (TES), and N-[Tris(hydroxymethyl)methyl]glycine (TRICINE).

25. The method of claim 1 wherein the sample is dissolved in a buffered organic solvent.

26. The method of claim 1 wherein the current produced by said electric field is in the range of 10 microamps to 5 milliamps.

27. The method of claim 1 wherein said electric field is in the range of about 50 volts per centimeter to about 900 volts per centimeter.

28. The method of claim 27 wherein said electric field is in the range of about 200 volts per centimeter to about 600 volts per centimeter.

29. The method of claim 1 further comprising the step of detecting the separated biomolecules.

30. The method of claim 29 wherein detection is selected from the group consisting of fluorescence, mass spectrometry, chemiluminescence, radioactivity, evanescent wave, label-free mass detection, optical absorption and reflection.

31. The method of claim 29, wherein detection is selected from a group consisting of MALDI-TOF mass spectrometry, and inductively-coupled plasma mass spectrometry

32. The method of claim 1 wherein the biomolecules are labeled with a detection agent prior to separation.

33. The method of claim 1 wherein the biomolecules are labeled with a detection agent after separation.

34. The method of claim 32 wherein said detection agent is selected from the group consisting of colored dyes, fluorescent dyes, chemiluminescent dyes, biotinylated labels, radioactive labels, affinity labels, mass tags, and enzymes.

35. The method of claim 1, further comprising the step of mass tagging said biomolecules for differential analysis of protein expression changes and post-translational modification changes.

36. The method of claim 35, wherein said mass tagging comprises the incorporation of two ¹⁸O or two ¹⁶O atoms in the carboxyl terminal moiety of proteolytic fragments of said biomolecule.

37. The method of claim 35, wherein said mass tagging comprises acetylation of primary amino groups in peptides with triacetate and trideuteroacetate.

38. The method of claim 35, wherein said mass tagging comprises methyl esterification of aspartate and glutamate residues with methanol and trideuteromethanol (d₃).

39. The method of claim 35, wherein said mass tagging comprises iodoacetylation on N-terminal of ¹²C and ¹³C labeled tri-alanine peptides.

40. The method of claim 35, wherein said mass tagging comprises the use of 1,2-ethanedithiol and tetraalkyl deuterated 1,2-ethanedithiol to measure differences between O-phosphorylation sites in samples.

41. The method of claim 1, further comprising the step of multiplexing for parallel determination of protein expression levels or other attributes of proteins.

42. The method of claim 41, wherein said protein expression levels comprises levels of glycosylation, levels of phosphorylation, and wherein said attributes of proteins comprises drug-binding capabilities and drug-metabolizing capabilities.

43. An electrochromatography system for the separation of biomolecules, the system comprising:
a chamber having at least bottom and side walls defining a planar electrochromatography area;
a first region within said chamber for containing a liquid mobile phase;
a second region within said chamber for containing said liquid mobile phase;
a planar amphiphilic stationary phase positioned between the first and second regions within said chamber and in contact with said liquid mobile phase;
first and second electrodes capable of electronic contact with the planar amphiphilic stationary phase; and
a power source capable of generating an applied electric potential between said first and second electrodes for performing planar electrochromatography.

44. The system of claim 43, wherein said first electrode, said second electrode, and said stationary phase are in contact with a planar wick.

45. The system of claim 44, wherein first end of said wick is in contact with said liquid phase in said first region and second end of said wick is in contact with said liquid phase in said second region.

46. The system of claim 43, wherein said first end and said stationary phase is in contact with a first wick, and wherein said second electrode and opposing end of said stationary phase is in contact with a second wick.

47. The system of claim 46, wherein said first wick is in contact with said liquid phase in said first compartment and said second wick is in contact with said liquid phase in said second compartment.

48. The system of claim 43, wherein said stationary phase is supported by one or more holders, wherein said holder is a frame with an opening in the center for contacting said stationary phase with said liquid mobile phase.

49. The system of claim 48, wherein said mechanical fastener is selected from a group consisting of rivets, eyelets, screws, snap tabs, and heat stakes.

50. The system of claim 48, further comprising alignment means for positioning said stationary phase held between two holders by mechanical means within said chamber, wherein said alignment means is selected from a group consisting of holes, slots, pins and datum surfaces.

51. The system of claim 43, further comprising a first and a second wick, wherein said first and second wicks is selected from a group consisting of cellulose-based filter paper, Rayon fiber, buffer-impregnated agarose gel, and moistened paper towel.

52. The system of claim 43, further comprising a dispenser for dispensing a sample on said stationary phase, wherein said dispenser is manual or automated.

53. The system of claim 52, wherein said manual dispenser is selected from a group consisting of pipette, piezoelectric dispensing tip, solid pin, and quill pin.

54. The system of claim 52, wherein said automated dispenser is a multiprobe liquid handling robot.

55. The system of claim 43, further comprising a controller for controlling the power supply unit, wherein said controlling means is selected from a group consisting of a computer, a programmable controller, a microprocessor, and a timer.

56. The system of claim 43, further comprising a cover.

57. The system of claim 56, wherein said first and second electrodes are integral with the cover and located at first opposing side walls of the chamber.

58. The cassette of claim 57, further comprising third and fourth electrodes integral with the cover and located at second opposing side walls of the chamber.

59. A kit for conducting electrochromatography, the kit comprising:
a planar amphiphilic stationary phase for loading a sample comprising two or more biomolecules;
at least one electrode buffer solution; and
an instruction booklet outlining instructions on how to use the kit for separating a sample comprising one or more biomolecules using planar electrochromatography.

60. The kit of claim 59, further comprising a wick, wherein said wick is selected from a group consisting of cellulose-based filter paper, Rayon fiber, buffer-impregnated agarose gel, and moistened paper towel.

61. The kit of claim 59, further comprising an impermeable barrier to cover said planar stationary phase, wherein said impermeable barrier is glass plate or silicone oil.

62. A cassette, comprising:
a frame comprising a base, side walls and a cover and having an inlet port and an outlet port for introducing and removing a fluid; and
a stationary phase supported in the frame, said stationary phase comprising an amphiphilic planar stationary phase.

63. The cassette of claim 62, further comprising a pair of electrodes integral with the cover and located at first opposing side walls of the frame.

64. The cassette of claim 63, further comprising a second electrode pair integral with the cover and located at second opposing side walls of the frame.

65. A planar stationary phase support, comprising:
a frame for supporting a planar stationary phase, said frame open in a center portion for exposing a surface of the planar stationary phase; and
a fastener for securing the planar stationary phase to the frame.

66. The planar stationary phase support of claim 65, wherein the frame comprises a recess for receiving a planar stationary phase.

67. The planar stationary phase support of claim 65, wherein the planar stationary phase is a polymer membrane.

68. The planar stationary phase support of claim 65, wherein the planar stationary phase is a silica, alumina or titania based thin layer chromatography resin.

69. The planar stationary phase support of claim 65, wherein said open center portion is substantially the size of the planar stationary phase.

70. The planar stationary phase support of claim 65, where the support comprises two opposing frames, said frames configured to secure a planar stationary between the opposing frames.

71. The planar stationary phase support of claim 65, wherein the stationary phase is secured to the frame by a mechanical fastener.

72. The planar stationary phase support of claim 71, wherein the mechanical fastener is selected from the group consisting of rivets, eyelets, screws, snaps, tabs, clamps, and gaskets.

73. The planar stationary phase support of claim 65, wherein the fastener comprises a crimp or fold of a portion of the frame over an edge of the planar stationary phase.

74. The planar stationary phase support of claim 65, wherein the stationary phase is secured to the frame by a chemical fastener.

75. The planar stationary phase support of claim 74, wherein the chemical fastener is selected from the group consisting of thermal welds, heat stakes, bonding agents and adhesives.

76. The planar stationary phase support of claim 65 further comprising alignment means for positioning the planar stationary phase relative to a predetermined location.

77. The planar stationary phase support of claim 76, wherein the alignment means is located at an edge of the frame or on a face of the frame.

78. The planar stationary phase support of claim 76, wherein the alignment means comprises a indentation or projection.

79. The planar stationary phase support of claim 78, wherein the indentation or projection is positionable to register with a complimentary indentation or projection.

80. The planar stationary phase support of claim 78, wherein the indentation or projection selected form a group consisting of holes, slots, pins and datum surfaces.

81. The planar stationary phase support of claim 76, wherein the alignment means comprises a spring set.
